(19) United States
(12) Patent Application Publication
(10) Pub. No.: US 2026/0087897 A1
(43) Pub. Date: Mar. 26, 2026

(54) DYNAMIC CONTEST NARRATIVE GENERATION

(71) Applicant: FanDuel Limited, Edinburgh (GB)

(72) Inventors: Catherine Everett, Hoboken, NJ (US); Lorcan Kelly, Los Angeles, CA (US); Stefan Borjesson, Porto (PT); Will Twinn, Jersey City, NJ (US)

(21) Appl. No.: 18/893,179

(22) Filed: Sep. 23, 2024

(51) Int. Cl. G07F 17/32; G06F 40/30

(52) U.S. Cl. CPC G07F 17/3288; G06F 40/30

(57) ABSTRACT

Systems, methods, and computer-readable media for narrative-driven wagering are disclosed. During a live contest, data from various data sources may be fed into a narrative model. The narrative model may identify a narrative for the live contest based on the data. The narrative may include an actor, a storyline, a sentiment, and a time frame. Based on the identified narrative, one or more wagers for the live contest may be identified. A parlay may be generated based on the wagers. The wagers may be surfaced to a user via a graphical user interface. A generative copy model may automatically generate copy for increasing user engagement with the wagers. The copy may include a headline and graphics that are generated based on the wagers and the narrative. User engagement with the wagers may be used to retrain the narrative model and the generative copy model.

### BACKGROUND

### 1. Field

Embodiments of the present disclosure relate to automatically determining narratives for contests such as sporting events. More specifically, certain embodiments of the present disclosure relate to the surfacing of wagers and generation of customized parlays for contests based on narratives surrounding the contests that can be identified in real time.

### 2. Related Art

Bettors have been wagering on contests for many years. Bettors tend to place similar, popular wagers on contests (e.g., sports), such as wagering on the outcome, the point spread, and the like. However, as betting proliferates and bettors become increasingly prolific, a desire for a more personalized wagering experience has emerged. Contests are often story-driven, with narratives developing both in the lead up to a contest and during the contest. For example, a storyline may develop surrounding a player in their first game back from a significant injury. As another example, a storyline may develop as a team begins to mount a second half comeback during a game. Bettors, accordingly, have a desire to place wagers that align with storylines developing during a contest to increase their investment in the contest.

There are various difficulties associated with providing real-time, narrative-driven wagers. The first difficulty that arises is in determining the narrative. Determining a narrative may involve analyzing large amounts of data, such as social media data, play-by-play data of the game, and the like to extract a narrative from the data. Additional difficulties arise in automatically identifying narratives during a contest as the state of the contest changes in real time. Another challenge exists with identifying markets that correspond to the narrative. Further challenges exist with risk management for a sportsbook offering narrative-driven parlays because the parlays will often include correlated wagers that leads to difficulty in pricing the parlay. Accordingly, what is needed are systems, methods, and computer-readable media for determining narratives for live contests, identifying wagers that correspond to the narratives, and surfacing the wagers to users.

### SUMMARY

Embodiments of the present disclosure solve the above-mentioned problems by providing systems, methods, and computer-readable media for generation of customized parlays and surfacing of wagers based on identified narratives of one or more contests. Before and/or during a live contest, data from a plurality of data sources may be analyzed to determine at least one narrative for the live contest. The data sources may include contest data of the contest (e.g., play-by-play data, statistical data, etc.), broadcast data for the contest (e.g., the audio feed of the commentators for the contest), social media data (e.g., posts about the contest), news data (e.g., articles or podcasts discussing the contest), and the like.

The data may be analyzed to identify a narrative, which may include at least an actor and a storyline. The actor may be a player or players, a team or teams, or a combination thereof. The storyline may be associated with an outcome, such as a specific outcome (e.g., win the game) or a more general outcome (e.g., the game being a nailbiter). A trained machine learning model may be configured to classify the data to identify the actor and/or the storyline. The storyline may be assigned a positive or negative sentiment. For example, the narrative for a game may be “high scoring,” which may be interpreted as a positive sentiment and, as such, the wager associated with this narrative may be the over on the points total. As another example, the narrative may be “is player X's career in decline?” and this negative sentiment may result in an under wager on a statistical proposition for player X being identified.

The narrative identification and subsequent parlay generation and/or market identification may enable new wagers being generated (the parlays) and less-popular markets being identified that correspond to storylines emerging during the contest. Accordingly, aspects of the present disclosure may also include automatic generation of a copy for the wager or parlay. The copy may be displayed to the user alongside the parlay or wager to increase user engagement with the wager. For example, if the narrative is that the quarterback Patrick is going to have a big game and the identified wager associated with this narrative is for Patrick to pass for over 400 yards, the copy generated may include a headline reading “Patrick's Prolific Passing.” The headline may include an emoji and/or other visuals to increase user engagement with the wager. In some embodiments, the headline is generated by a generative artificial intelligence model.

In some embodiments, the techniques described herein relate to one or more non-transitory computer-readable media storing computer-executable instructions that, when executed by at least one processor, perform a method of dynamically generating parlays based on narratives identified during a live contest, including: receiving a training data set for training a machine learning model, the training data set including historical contest statistical data; training the machine learning model to identify narratives associated with live contests using the training data set; receiving, during a live contest, data associated with the live contest from a plurality of data sources; determining, using the machine learning model and based on the data, a narrative for the live contest, the narrative including at least one actor and at least one sentiment; identifying two or more wagers associated with the at least one actor and corresponding to the at least one sentiment; generating a parlay based on the two or more wagers; generating, using a generative artificial intelligence model, a copy for the parlay based on the at least one actor or the at least one sentiment; and surfacing the parlay including the copy to a user via a graphical user interface.

In some embodiments, the techniques described herein relate to a media, further including: determining, while the live contest is ongoing, a new narrative associated with the live contest; and responsive to determining the new narrative, surfacing a second parlay with a second copy to the user via the graphical user interface.

In some embodiments, the techniques described herein relate to a media, wherein the copy includes a headline and at least one graphical associated with the narrative.

In some embodiments, the techniques described herein relate to a media, wherein the data includes an image of a broadcast graphic received from the user, and wherein the narrative is further based in part on the image.

In some embodiments, the techniques described herein relate to a media, wherein the data includes social media data including one or more posts associated with the live contest.

In some embodiments, the techniques described herein relate to a media, wherein determining the at least one sentiment is based on sentiment analysis of the one or more posts.

In some embodiments, the techniques described herein relate to a system for generating parlays based on identified live contest narratives, the system including: at least one processor; and one or more non-transitory computer-readable media storing computer-executable instructions that, when executed by the at least one processor, cause the system to carry out actions, including: receiving, during a live contest, data associated with the live contest from a plurality of data sources; determining, based on the data, a narrative for the live contest, the narrative including at least one actor and at least one sentiment; identifying two or more wagers associated with the at least one actor and corresponding to the at least one sentiment; generating a parlay based on the two or more wagers; generating, using a generative artificial intelligence model, a copy for the parlay based on the at least one actor or the at least one sentiment; and surfacing the parlay including the copy to a user via a graphical user interface.

In some embodiments, the techniques described herein relate to a system, wherein the actions further include: determining, while the live contest is ongoing, a new narrative associated with the live contest; and responsive to determining the new narrative, surfacing a second parlay with a second copy to the user via the graphical user interface.

In some embodiments, the techniques described herein relate to a system, wherein the actions further include: receiving user interaction data of user interactions with the copy; and adjusting the generative artificial intelligence model based on the user interaction data.

In some embodiments, the techniques described herein relate to a system, wherein the plurality of data sources includes an audio data source of a broadcast of the live contest.

In some embodiments, the techniques described herein relate to a system, wherein the actions further include: receiving a training data set for training a machine learning model to identify the narrative; and training the machine learning model using the training data set, wherein the training data set includes historical statistical data.

In some embodiments, the techniques described herein relate to a system, wherein at least one of the plurality of data sources includes an image of a graphic of a broadcast of the live contest.

In some embodiments, the techniques described herein relate to a system, wherein the at least one actor includes a player participating in the live contest.

In some embodiments, the techniques described herein relate to a method for surfacing wagers based on narratives identified during live contests, including: receiving a training data set for training a machine learning model, the training data set including narrative data associated with narratives of contests; training the machine learning model to identify narratives associated with live contests using the training data set; receiving, during at least one live contest, statistical data for the at least one live contest; identifying, using the machine learning model, a narrative for the at least one live contest, the narrative including at least one actor and a storyline; determining a plurality of wagers associated with the at least one actor and the storyline; and surfacing, to a user and via a graphical user interface, at least one of the plurality of wagers.

In some embodiments, the techniques described herein relate to a method, wherein the at least one actor includes at least one of: one or more players of the at least one live contest or one or more teams of the at least one live contest.

In some embodiments, the techniques described herein relate to a method, further including: automatically generating a headline for the at least one of the plurality of wagers surfaced to the user; and causing display of the headline to the user with the at least one of the plurality of wagers.

In some embodiments, the techniques described herein relate to a method, wherein the training data set includes broadcast data from a live broadcast of the at least one live contest.

In some embodiments, the techniques described herein relate to a method, wherein the broadcast data includes audio data and one or more graphics.

In some embodiments, the techniques described herein relate to a method, wherein the storyline is associated with at least one of a positive sentiment or a negative sentiment.

In some embodiments, the techniques described herein relate to a method, wherein the at least one live contest includes a first live contest and a second live contest occurring simultaneously.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE FIGURES

Embodiments of the present disclosure are described in detail below with reference to the attached drawing figures, wherein:

FIG. 1 depicts an exemplary hardware platform relating to some embodiments;

FIG. 2A illustrates an exemplary block diagram relating to a wagering system for some embodiments;

FIG. 2B illustrates an exemplary block diagram relating to a narrative engine of the wagering platform for some embodiments;

FIG. 3 illustrates an exemplary machine learning model relating to some embodiments;

FIGS. 4A-4B illustrate exemplary user interfaces for some embodiments;

FIG. 5 illustrates an example scenario for determining a narrative of a live contest for some embodiments; and

FIG. 6 illustrates an exemplary method for some embodiments.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized and changes can be made without departing from the scope of the present disclosure. The following detailed description is, therefore, not to be taken in a limiting sense. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Embodiments of the present disclosure are generally directed to systems, methods, and computer-readable media for identification of wagers and creation of parlays based on narratives identified during live contests. During a live contest, a narrative associated with the contest may be identified. The narrative may be user-specified, automatically identified based on data from various sources, or a combination thereof. Narratives may include an actor (such as a player or a team), a storyline, a sentiment, a time frame, or any combination thereof. As a simplistic example, play-by-play data for a live football game may indicate a team is losing at halftime and social media posts about the game may include a number of posts about the losing team making a second half comeback. Thus, based on the identified narrative of the team (actor) making a second half comeback (storyline), one or more markets offered by the sportsbook may be mapped to the identified narrative and surfaced to users. For example, a first identified market may be a moneyline market for the team winning the game (i.e., making the comeback), a second identified market may be the team's quarterback throwing for multiple touchdowns in the second half (corresponding to the time frame), and a third identified market may be the opposing team's second half points. The storyline may be associated with a sentiment (e.g., positive, negative, neutral, etc.) that determines which wager for the identified market is identified. For example, because the sentiment associated with the team making a second half comeback is a positive sentiment, the wager for the moneyline market may be for the currently-losing team, the wager for the touchdowns may be an over wager, and the wager for the opposing team's second half points may be the under, as each of these wagers corresponds to the currently-losing team making the second half comeback.

Once the markets are identified, the markets may be combined into a customized parlay and/or may be individually surfaced to the user. One advantage of the present disclosure is that the identified markets may often include markets that are less accessible to users of the sportsbooks. For example, a sportsbook may offer hundreds of markets on a certain game, with a subset of those markets being less prominent in the user interface, such that certain users are less likely to wager on these markets because the users may be unaware that the markets are offered at all. Accordingly, by surfacing the markets to the user, the user experience is improved as the user can place wagers on markets that they were previously unaware of and that aligns with the identified narrative.

When surfacing wagers and/or customized parlays (also referred to generally as wagers herein) to users, copy for the surfaced wagers may be automatically generated. The copy may be generated based on the identified narrative, the mapped wagers, or both. For example, the copy may include a headline reading “A Comeback is Brewing!” for the team to make a second half comeback. Including the automatically generated copy may increase user engagement with the wager.

Various aspects of the present disclosure may be implemented using machine learning models and/or artificial intelligence models. For example, the identification of narratives may be performed using a trained machine learning model configured to classify data associated with live contests to identify actors and storylines to obtain a narrative. Another machine learning model may be trained to identify wagers offered by the sportsbook that correlate to the narrative. The headlines may be automatically generated via a generative artificial intelligence model (e.g., a generative adversarial network) and based on the identified narrative, the identified wagers corresponding to the narrative, or both.

Embodiments of the present disclosure solve the technical problems associated with real-time generation of customized wager offerings based on narratives associated with live contests by providing improved machine learning models and generative artificial intelligence models for real-time narrative identification and generation of copy for wagers and parlays, which may improve the efficiency at which data is processed and may result in narrative-based parlays to be more quickly computed.

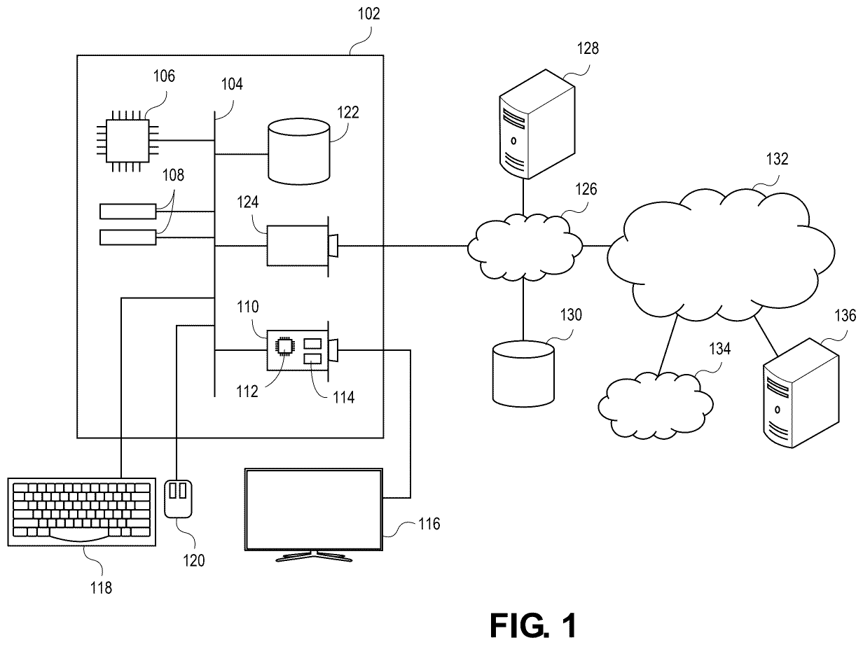

Turning to FIG. 1, an exemplary hardware platform for certain embodiments is depicted. Computer 102 can be a desktop computer, a laptop computer, a server computer, a mobile device such as a smartphone or tablet, or any other form factor of general-or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple buses or components may communicate with each other directly. Connected to system bus 104 is central processing unit (CPU) 106. Also attached to system bus 104 are one or more random-access memory (RAM) modules 108. Also attached to system bus 104 is graphics card 110. In some embodiments, graphics card 110 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments, no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media and may be internally installed in computer 102 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently and may be non-transitory computer-readable media storing data or computer-executable instructions. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 124 is also attached to system bus 104 and allows computer 102 to communicate over a network such as local network 126. NIC 124 can be any form of network interface known in the art, such as Ethernet, ATM, fiber, Bluetooth®, or Wi-Fi (i.e., the IEEE 102.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write, and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

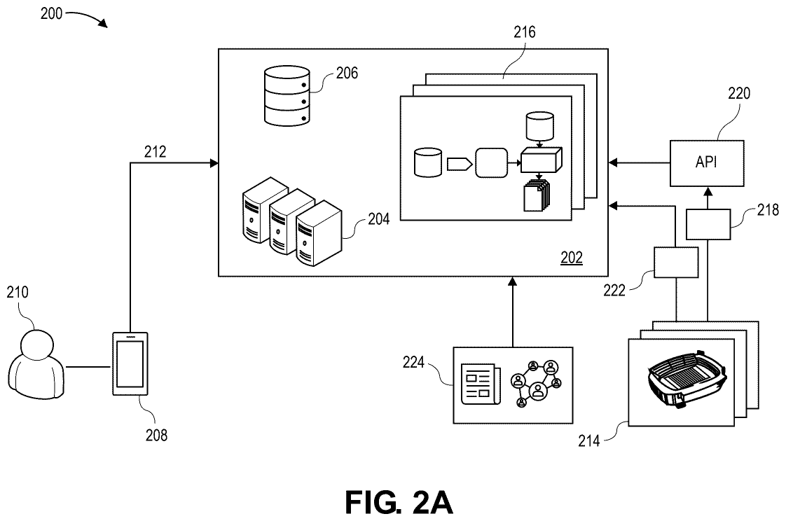

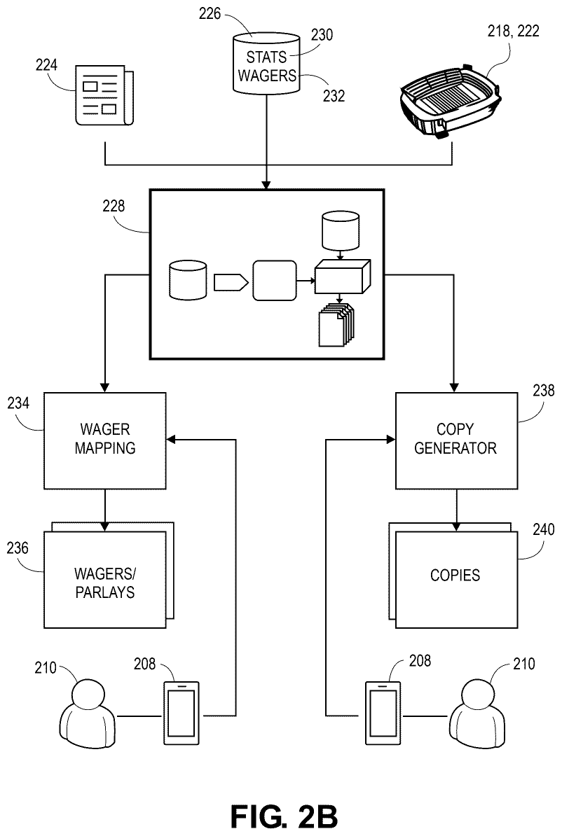

FIG. 2A illustrates an exemplary block diagram 200 of wagering platform or system 202 in accordance with embodiments of the present disclosure. System 202 may include one or more servers such as server 204. In at least one example, the server 204 can include one or more servers or other types of computing devices that can be embodied in any number of ways. For example, the functional components and data of the server can be implemented on a single server, a cluster of servers, a server farm or data center, a cloud-hosted computing service, a cloud-hosted storage service, or the like. Server 204 may be coupled to one or more databases such as databases 206. Databases 206 may store various data for system 202, such as statistical data of past and live contests and user wagering data.

The server 204 can communicate with user computing device 208, which may be operated by a user 210, via one or more networks such as network 212. The server 204 and the computing device 208 can transmit, receive, and/or store data (e.g., content, information, or the like) using the network 212. The user computing device 208 can be any suitable type of computing device, such as a tablet computing device, a smart phone, a laptop, a desktop computing device, or any other computing device discussed above with respect to FIG. 1. While a single computing device 208 is illustrated, any number of computing devices operated by any number of users may communicate with system 202. The computing device 208 can, among other functions, be operable by user 210 to interface with the wagering system 202 to place wagers on contests in accordance with embodiments of the present disclosure. For example, the computing device 208 may execute an application for interfacing with server 204 to place wagers on contests.

Network 212 can include, but is not limited to, any type of network known in the art, such as a local area network or a wide area network, the Internet, a wireless network, a cellular network, a local wireless network, Wi-Fi and/or close range wireless communications, Bluetooth®, Bluetooth Low Energy (BLE), Near Field Communication (NFC), a wired network, or any other such communication network, or any combination thereof.

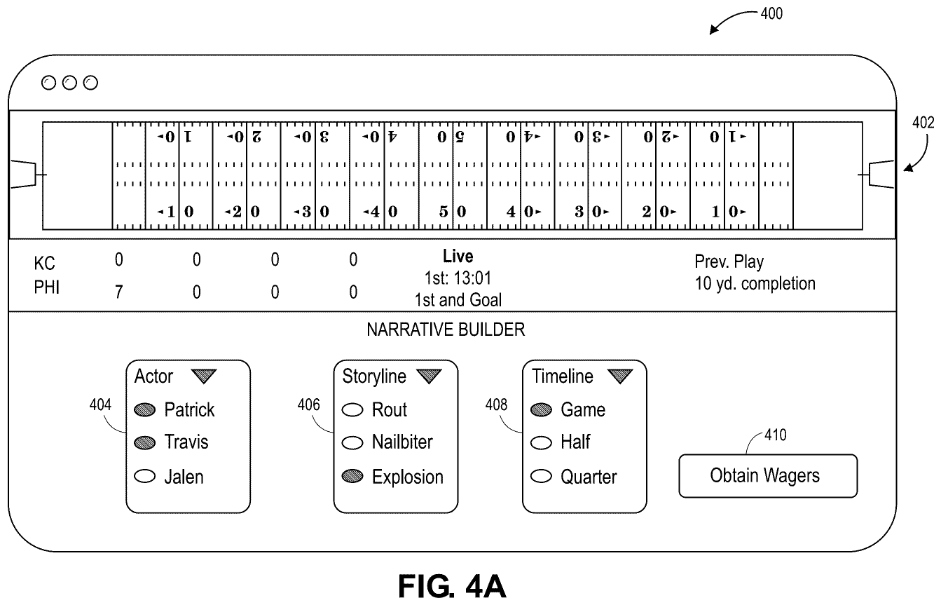

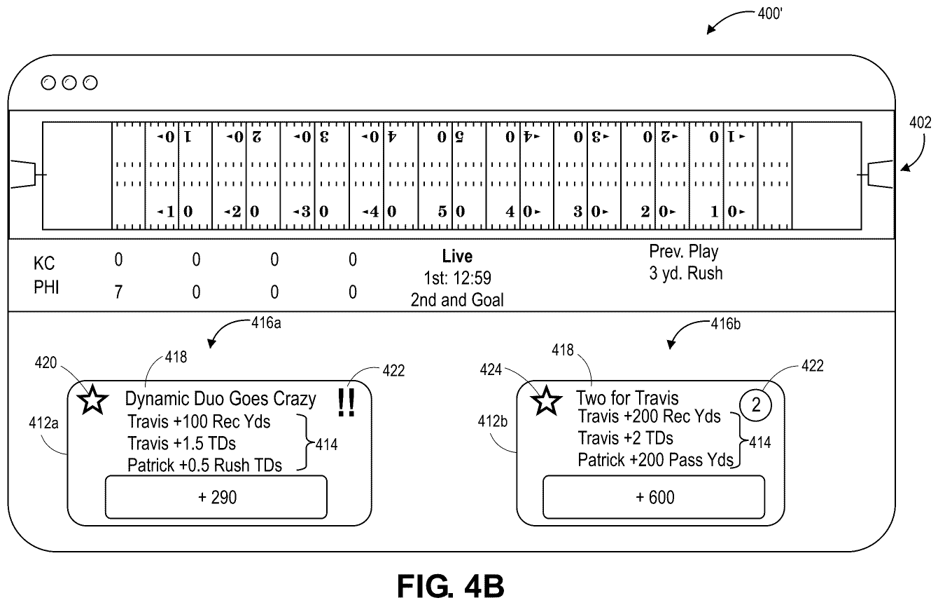

As discussed, user 210 may place wagers on live contests 214, which may be events, such as sporting events, eSports, or the like. During a live contest 214, server 204 may be configured to identify narratives associated with one or more live contests 214 to create and/or promote wager offerings (e.g., markets and parlays) based on the identified narrative. Narratives may also be determined prior to a contest beginning. As one example, server 204 may be configured to receive real-time, play-by-play data of a live contest 214, which may indicate that a player is on pace to have a record-breaking game. Upon determining that the player is on pace to have the record-breaking game, server 204 may be configured to promote wagers relating to the record-breaking game and/or create a parlay based on wagers relating to the record-breaking game. For example, a first wager relating to the record-breaking game may be a proposition wager on the player breaking the record and a second wager relating to the record-breaking game may be the team also winning the game. These two wagers may then be combined together to create a parlay that may be surfaced to user 210. For example, the user 210 may interface with server 204 via a mobile application provided by system 202 that may include a “live page” for the user 210 to follow along with the live contest 214 during the live contest, and the created parlay may be surfaced to the user 210 via this page such that the user 210 can place a wager on the parlay to bet on the narrative that is taking place (the record-breaking game) playing out. An exemplary user interface depicting a live page is discussed in further detail below with respect to FIGS. 4A-4B.

In some embodiments, the server 204 comprises or is otherwise associated with a one or more models 216 configured to (1) identify narratives for live contests, (2) identify wagers corresponding on the narratives, and (3) generate copy for increasing user engagement with the identified wagers. In some embodiments, models 216 includes a narrative engine configured as a trained machine learning model that ingests data associated with the live contest 214 and identifies and/or classifies a narrative based on the ingested data. The narrative may include at least one of an actor, a storyline, a sentiment, a time frame, or any combination thereof. The actor may be the person(s) and/or team(s) being wagered on. The storyline may be an outcome associated with the actor (e.g., X team will win the game). The sentiment may be a positive, negative, or neutral sentiment and may be determined based on the storyline or may be independent from the storyline. The time frame may be any period of time associated with the wager (e.g., a half of a football game, an entire season, etc.). For example, the actor may be a group of teams playing a set of contests within a common time frame (e.g., all NFL football games that kickoff at the same time on Sunday), the storyline may be an offensive struggle, and the time frame may be a single game. Thus, the identified narrative may be the games all being low scoring because of the storyline being the offensive struggle. Accordingly, server 204 may create parlays such as a parlay that all the games associated with the narrative finish under the projected points total.

In some embodiments, models 216 further include a wager mapping model for identifying one or more wagers that correspond to the identified narrative. In some embodiments, models 216 further includes a copy generator, which may be a generative artificial intelligence model configured to generate copy based on the identified narrative, the identified markets, other data sources, or any combination thereof. In some embodiments, models 216 are configured to identify narratives, map wagers, generate copy, or any combination thereof based on data received from various data sources. The narrative engine, the wager mapping engine, the copy generative model are each discussed further below with respect to FIG. 2B.

In some embodiments, system 202 is coupled to various data sources for receiving data from the data sources for processing by models 216. The data may be stored data (e.g., in database 206), data received in real time, or both. In some embodiments, the data includes play-by-play data 218 from live contest 214, which may be received via an API 220 in some embodiments. System 202 may be subscribed to in a publisher-subscriber (PubSub) architecture. For example, the API 220 may publish messages containing play-by-play data 218 substantially in real-time (e.g., about every two seconds). Broadcast data 222 may also be communicated to system 202 for use by models 216. Other data sources 226 may include social media data, media data, which may be obtained prior to the live contest beginning (e.g., articles, podcasts, television shows, etc.), and the like. In some embodiments, data leveraged to determine a narrative, map wagers, or generate copy may include data stored in database 206, which may include statistical data for players and teams participating in the live contest 214, historical wager data relating to user 210 and/or to multiple users, past narratives, and the like. For example, past narrative data for a team may indicate the team (actor) is on a losing streak (storyline), and this data combined with play-by-play data 218 indicating the team is off to a hot start in the contest, may be used by models 216 to identify a narrative of the team bucking the trend of the losing streak, which may be used to generate custom parlays and surface wagers relating to the identified narrative as discussed in further detail below. The various data sources that may provide data as input to models 216 are discussed in further detail below.

Turning now to FIG. 2B, system 202 is illustrated in further detail showing the various models 216 that may be employed in accordance with aspects of the present disclosure. Models 216 may include a narrative engine 228 configured to identify a narrative based on data from the live contest 214. As previously discussed, play-by-play data 218 from a live contest 214 may be analyzed for narrative identification. For example, the play-by-play data 218 may indicate that a player is on track to break a single game record, and therefore, the narrative engine 228 may identify a narrative relating to the player breaking the single game record. In some embodiments, API 220 provides a JSON or XML package that contains a plurality of fields from which statistical data can be extracted and compared to historical data stored in database 206 (e.g., to determine whether a player is having a record breaking game).

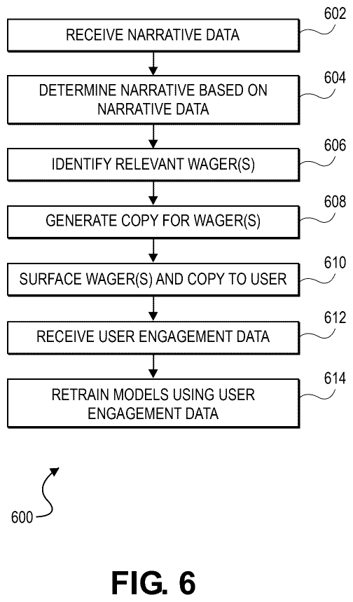

In some embodiments, narrative engine 228 is configured to identify a narrative based at least in part on broadcast data 222. The broadcast data 222 may include any information received from the broadcast of the live contest 214. For example, the audio feed from the in-game commentary may be transcribed in real time and analyzed to determine a narrative for the contest 214. Keyword matching, natural language processing (NLP), and other similar techniques may be employed to determine the narrative or a portion thereof based on the transcribed commentary in some embodiments. It will be appreciated that other commentary (e.g., a pre-game show or a halftime show) may also be analyzed for determining a narrative. For example, during a half time for a football game, halftime analysts may be discussing that a team's quarterback played a poor first half but is poised to have a big second half. Narrative engine 228, accordingly, may identify a narrative surrounding the quarterback having a bounce back second half based on the half time commentary. Other broadcast information may similarly be leveraged to determine narratives. As one example, the video feed for a broadcast may also be analyzed by narrative engine 228 for narrative identification. For example, while the halftime analysts are discussing the quarterback's poor performance, a graphic may be displayed with the quarterback's statistics, which may also influence the identification of the bounce back narrative. For example, if the graphic displays the quarterback's poor first half stats alongside the quarterback's historically strong second half stats, narrative engine 228 may be configured to identify the narrative as the quarterback having a strong second half. An example scenario for determining narratives based on broadcast graphics is discussed further below with respect to FIG. 6.

In some embodiments, narrative engine 228 is configured to analyze social media data 224. The social media data 224 may include posts about the game, for example, upon which sentiment analysis and other NLP techniques, such as topic modeling, may be performed to identify a narrative for the game. The social media data 224 may include only posts made while the live contest is ongoing, in some embodiments, such that the narratives that evolve during a game may be identified. In some embodiments, narrative engine 228 is configured to weight posts from certain users higher than other users. For example, posts from verified users (e.g., reporters or analysts) may be given higher weight when determining narratives based on social media posts.

In some embodiments, social media data 224 may include posts made prior to a game such that narratives that form in the lead up to a contest can be identified. By identifying the narratives leading up to a contest, the in-game narratives identified by analyzing real-time social media data 224 (in addition to the other data discussed herein in some embodiments), may be compared against the pregame narratives for determining which markets to surface to users. For example, if a narrative shift is detected, narrative engine 228 may surface markets associated with the narrative shift above markets for newly identified narratives. For example, if before the game a first narrative was identified relating to the home team being expected to win and during the game a second narrative developed relating to the away team upsetting the home team and a third narrative developed relating to a player having a historically bad game, narrative engine 228 may weight the second narrative higher than the third narrative because of the association of the second narrative with the pre-existing first narrative, which may be more appealing to users to wager on.

In some embodiments, other data sources 226 may be provided as input for determining a narrative. For example, data sources 226 may include media related to the contest, such as articles, podcasts, television shows, radio shows, or the like that may be analyzed by narrative engine 228 to determine a narrative. Statistical data 230 may also be leveraged by narrative engine 228 in determining narratives. The statistical data 230 may be historical statistical data associated with actors (e.g., players and/or teams) participating in the live contest 214. For example, the statistical data 230 may be used to identify narratives before a live contest 214 begins and may be compared to play-by-play data 218 received throughout the live contest 214 to identify narratives developing over the course of the contest. For example, if the play-by-play data 218 indicates that a player is having a game that contrasts with the player's typical performance (as determined from statistical data 230), narrative engine 228 may identify this contrast in the data as a narrative. Similarly, if the play-by-play data 218 indicates that the player is continuing with a recent trend in play, narrative engine 228 may likewise identify this as a narrative.

In some embodiments, wager data 232 is input to 228//for determining a narrative. The wager data 232 may include historical wager data for user 210 and/or for a plurality of users of wagering system 202. As with the other data types discussed herein, narrative engine 228 may be configured to process wager data 232 to identify a narrative. For example, wager data 232 may indicate that user 210 has in the past wagered on a player that has been identified by narrative engine 228 as being involved with a developing narrative for live contest 214 (e.g., by analyzing play-by-play data 218, broadcast data 222, and the like). Thus, in combination with wager data 232, narrative engine 228 may identify a narrative surrounding the player and the user's wager history.

Narratives may be identified based on a volume of bets placed on wagers offered by system 202. While a live contest 214 is ongoing, the wager activity of users may be fed into narrative engine 228 to determine actors, storylines, sentiments, timeframes, or any combination thereof associated with the wager activity to determine a developing narrative. As an example, a first wager and a second wager are each being rapidly bet on by users, a narrative may be extracted from the wagers.

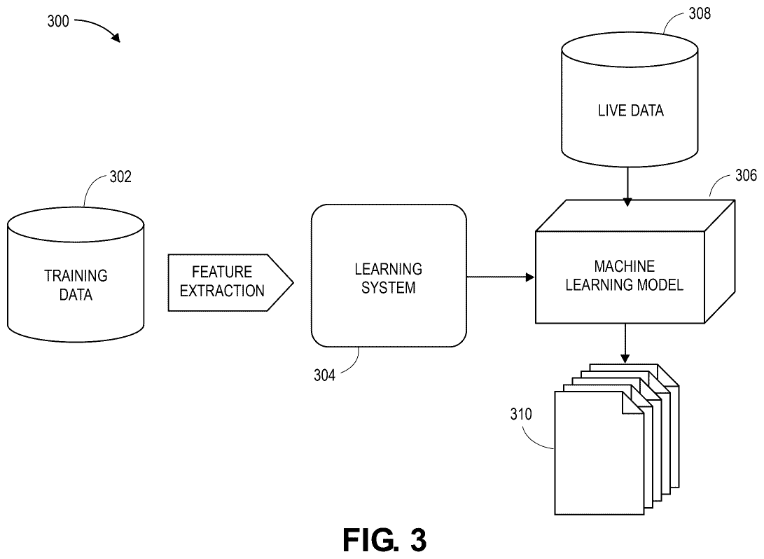

As discussed further below with respect to FIG. 3, narrative engine 228 may be implemented as a trained machine learning model configured to classify the data from at least one of the above-described data sources into a narrative including an actor, a storyline, a sentiment, a time frame, or any combination thereof. In some embodiments, narrative engine 228 is trained using historical data of any of play-by-play data 218, broadcast data 222, social media data 224, data from other data sources 226, statistical data 230, or wager data 232. For example, narrative engine 228 may be trained to classify the data into a storyline. In some embodiments, narrative engine 228 may be trained to determine the actor associated with the storyline. For example, database 206 may store a set of actors associated with the live contest 214 (e.g., a player roster), and narrative engine 228 may classify the data inputs as either associated with a specific player or not associated with a specific player.

In some embodiments, narrative engine 228 is additionally configured to determine a time frame for the narrative. The time frame may be the period of time over which the narrative plays out. For example, for a second half comeback narrative, the time frame would be the second half of the game. As another example, during a live contest 214, broadcast data 222 may include the announcers excitedly discussing a baseball team's chances to make the World Series such that the identified narrative has a time frame of season-long or post season or the like, which may result in a futures wager being promoted to the user 210, as discussed further below.

Models 216 may further include a wager mapping engine 234. Similar to narrative engine 228, wager mapping engine 234 may be a trained machine learning model for employing aspects of the present disclosure. In some embodiments, wager mapping engine 234 is configured to map or identify wagers based on the narrative identified by narrative engine 228. Accordingly, wager data 232 may receive the narrative identified by narrative engine 228 as input. In some embodiments, wager mapping engine 234 is configured to generate customized parlays based on the identified wagers. Thus, users 210 may be presented with dynamically generated parlays that are generated based on narratives identified in real time based on events occurring during a live contest. The wagers may then be displayed to user 210 via a graphical user interface as discussed in further detail below.

In some embodiments, wager mapping engine 234 is trained to map the narrative to one or more wagers 236 offered by the sportsbook. For example, if the identified narrative is Player X is going to have a breakout game, wager mapping engine 234 may be configured to identify markets involving Player X and may identify the wager(s) 236 that involve the positive outcome on the market as being mapped to the identified narrative. For example, if Player X is a baseball player, the market mapped to the narrative of Player X having a breakout game may be the Player X's hits total, and wager mapping engine 234 may map the over on Player X's hits total as the wager that should be surfaced to the user 210 because this wager matches the identified narrative.

The wagers 236 identified by wager mapping engine 234 may include individual wagers (i.e., single bets) and may also include parlays. In some embodiments, wager mapping engine 234 is configured to create one or more parlay wagers 236 from the mapped wagers 236. For example, as part of the breakout game narrative, narrative engine 228 may identify another market corresponding to this narrative, such as a market for Player X to hit a homerun. This market may then be combined with the hits total market into a parlay wager 236. This customized parlay may be given a set of odds based on the likelihood of the two events both occurring, which may be based in part on the two events being correlated.

In some embodiments, the identified wagers 236 are custom wagers. In some embodiments, system 202 is configured to provide custom wagers that are dynamically generated and priced in real-time and offered to the user. System 202 may cause the generation of the custom wager that aligns with the identified narrative. In some embodiments, the custom wager is priced based on running a plurality of simulations of the contest associated with the wager and determining the probabilities of events occurring based on the simulation results. The simulations may be based on historic contest data, among other data. For example, the simulations may be Monte Carlo simulations.

The custom wagers may be generated in real-time and/or in response to an identified narrative. For example, if the identified narrative is a shootout between two teams, server 204 may generate a custom wager that corresponds to the shootout narrative. In some embodiments, wager mapping engine 234 is configured to generate a query for the custom wager that is analyzed by server 204 to price the custom wager. Server 204 may be configured to operate using a specific query language which, in some embodiments may be a Probability Query Language (PQL), and wager mapping engine 234 may provide the query to server 204 in that language. For example, the custom wager may be a points total that was not previously offered. Prior to the beginning of the shootout contest, a points total of 40 may have been offered, along with alternative lines such as in increments of five above and below 40. Because of the identified shootout narrative, it may be desirable to offer a custom wager for a points total of 63, for example, which had not previously been offered. Accordingly, server 204 may generate a customer wager for the 63 point total, and wager mapping engine 234 may map this custom wager to the narrative. Thus, embodiments of the present disclosure contemplate mapping both pre-configured wagers and custom wagers to an identified narrative, which may be requested (i.e., queried) by wager mapping engine 234 based on the identified narrative.

The generation of custom wagers (also referred to as user-requested markets), including querying an outcome matrix for a custom wager/user-requested market, is discussed in further detail in U.S. Application Serial No. [Docket No. 2794-9.00], titled “LOW LATENCY USER DIRECTED MARKET GENERATION” and filed Mar. XX, 2024, which is incorporated by reference in its entirety into the present application.

Users 210 may interact with the presented wagers 236 (via computing device 208), and this interaction data may be provided to wager mapping engine 234 as feedback and/or for further training and adjustments of the model's weights and the like. Users 210 may also provide direct feedback on the wagers 236, e.g., a thumbs up or thumbs down ratings system on the relevance of wagers 236 to the identified narrative (as communicated by the copy), which may be provided as feedback to wager mapping engine 234. Thus, the mapping of wagers to the identified narrative may be improved over time.

Models 216 may further comprise a copy generator 238. Copy generator 238 may be configured as a generative artificial intelligence model in some embodiments and may receive narratives from narrative engine 228, wagers 236 from wager data 232, data from any of the described data sources, or any combination thereof as input. Copy generator 238 may be configured to generate custom copy for the wagers and/or parlays mapped by wager mapping engine 234. The copy 240 may be surfaced to user 210 along with the markets and may be configured to increase user engagement in betting on the wagers 236. As with wager mapping engine 234, users 210 may provide feedback that may be used to train copy generator 238. Feedback in the form of user engagement data may cause copy generator 238 to adjust the generation of copy 240. For example, the user 210 not interacting with the wager 236 or interacting with the wager 236 but not placing a bet on the wager 236 may be user engagement data used to adjust the output of copy generator 238.

FIG. 3 illustrates an exemplary machine learning architecture 300 in accordance with embodiments of the present disclosure. Machine learning architecture 300 may be embodied as any of narrative engine 228, wager mapping engine 234, copy generator 238. In some embodiments, architecture 300 includes training data 302 for training the machine learning model. In order to train narrative engine 228, training data 302 may include statistical data 230, prior narrative data that may be stored in database 206, broadcast data 222, social media data 224, or any other type of data discussed herein for identifying narratives. For example, narrative engine 228 may be trained on statistical data 230 to identify trends in the statistical data 230 may be indicative of a storyline or sentiment for an actor, such as a team being on a hot streak, or the like. Similarly, projection data for upcoming matchups may be provided as training data to determine narratives.

In order to train wager mapping engine 234, the training data may include narratives (e.g., as identified by narrative engine 228 and/or provided by a subject matter expert) and markets offered by the sportsbook. For training the copy generator 238, the training data 302 may include historical headlines, a headline repository, along with narratives and wagers from which the headlines are generated.

Feature extraction may be performed on the training data 302 to extract features from the training data 302 as will be appreciated by one of skill in the art. A learning algorithm 304 then be trained on the processed training data 302 to obtain a trained machine learning model 306. In some embodiments, the learning algorithm 304 is a classification algorithm as previously discussed. For example, wager mapping engine 234 may be trained to classify wagers as either associated or not associated with a given narrative. Narrative engine 228 may likewise be configured as a classifier. In some embodiments, the learning algorithm 304 is a generative AI algorithm for generating copy.

Thus, the trained machine learning model 306 may receive live data 308 and may produce an output 310 based on the live data 308. As discussed above, narrative engine 228 may be configured to receive live data 308, which may include broadcast data 222, social media data 224, data sources 226, and the like, to identify a narrative output 310 based on the live data 308. The narrative engine 228 may identify from the live data 308 at least one actor, at least one storyline and/or sentiment, a time frame, or any combination thereof.

In some embodiments, wager mapping engine 234 is a classifier for classifying wagers as associated with or not associated with the identified narrative as output 310. Additionally, wager mapping engine 234 may be configured to combine two or more of the mapped wagers 236 into a parlay as previously discussed. Live data 308 provided to wager mapping engine 234 may include the narrative generated by narrative engine 228 in some embodiments. Statistical data 230, or any other data, may also be provided to wager mapping engine 234. For example, providing statistical data 230 may ensure that wager mapping engine 234 does not map wagers that are obsolete or may soon become obsolete. Thus, wagers 236 that may be met in the near future may be removed from the pool of wagers that can be mapped to the narrative. For example, if the narrative is that a running back may break the single game rushing yard and is already at 150 yards of rushing in the game, providing this play-by-play data 218 may prevent a market for the running back to rush for over 160 yards as being mapped to the narrative because of the high likelihood that the running back will soon eclipse this statistic, which may be unfavorable for the sportsbook to offer for risk management purposes. In contrast, the wager mapping engine 234 may be configured to instead map a market for the running back to eclipse 300 yards rushing.

As previously discussed, copy generator 238 may be a generative AI model configured to generate copy 240 for display with wagers 236 that are mapped by wager mapping engine 234 as relevant to the narrative identified by narrative engine 228. For example, copy generator 238 may be a generative adversarial network (GAN) configured to produce copy 240. The GAN may be trained based on real-world copy data (e.g., using a repository of templates) and fake copy data produced by a generator. In operation, copy generator 238 may receive either or both of the narrative identified by narrative engine 228 or the wagers mapped by wagers 236 as live data 308. Copy generator 238 may then use this data to generate copy 240 as previously discussed. The copy 240 may be surfaced with the wagers 236 in user interfaces, as shown below with respect to FIGS. 4A-4B.

Turning now to FIG. 4A, a narrative-builder user interface 400 is illustrated for some embodiments of the present disclosure. Narrative-builder user interface 400 may enable users 210 to provide one or more parameters to create a user-defined narrative, which wagering system 202 may use to generate customized parlays for the user 210 and/or surface markets that correspond to the narrative to the user 210. User interface 400 may include a live game pane 402 that displays real-time data for the live contest. For example, for the football game illustrated, the pane 402 displays play-by-play information, and may also include graphics that indicate the current line of scrimmage, the direction the offensive team is going, and the like. Other play-by-play information may also be displayed. Thus, user 210 can follow along with the game in real time via live game pane 402 while placing wagers on the contest even if the user 210 is not watching the contest. It will be appreciated that the live pane 402 may vary based on the contest being viewed by the user 210. For example, live game pane 402 for a baseball game may display live data for the baseball game.

In some embodiments, user 210 can define a narrative by inputting at least one of an actor parameter 404, a storyline parameter 406, a time frame parameter 408, or any combination thereof. In some embodiments, the user 210 can indicate multiple of each parameter 404, 406, 408, such as multiple actor parameters 404, for building a narrative. As previously discussed, the actor parameter 404 may allow the user 210 to indicate one or more individuals or one or more teams associated with the live contest(s) 214 for the narrative. The storyline parameter 406 may involve the selection of a potential outcome, set of events, or sentiment. An example of an outcome is “win the Super Bowl,” while an example of a storyline is “rivalry game” or “comeback game.” While not shown in FIG. 4A, it is contemplated that a sentiment parameter may also be provided by the user 210. Alternatively, in some embodiments, the sentiment is determined based on the selected storyline. In some embodiments, predefined storylines are provided (e.g., rivalry game, rout, etc.) that have sentiments associated therewith. In some embodiments, multiple sentiments are associated with a storyline. For example, the “rout” storyline for a selected team may have a positive sentiment for the selected team and a negative sentiment for the opposing team being routed. Thus, in some embodiments, each actor in the narrative is assigned a sentiment.

The time frame parameter 408 may comprise a time period for the selected storyline such as “quarter,” “full game,” or “season long.” As such, for example, the user 210 could specify a narrative with an actor parameter 404—Patrick and Travis, storyline parameter 406—explosion, and time frame parameter 408—game. In some embodiments, the time frame parameter 408 is omitted, and engines 228, 234 may determine a time frame based on the state of the live contest 214, which may be determined based on play-by-play data 218 in some embodiments. In some embodiments, the parameters 404, 406, 408 are pre-populated based on narratives identified by narrative engine 228 before and/or during a live contest 214. Thus, the user 210 may then select the narratives surrounding the contest 214 that they wish to see wagers and/or parlays that correspond to the selected narrative playing out.

User interface 400 may include an obtain wagers affordance 410. Once parameters 404, 406, 408 have been set by user 210, user 210 may select obtain wagers affordance 410 to obtain wagers 236 associated with the set narrative. Thus, the parameters 404, 406, 408 may be input to wager mapping engine 234 as live data 308. These parameters 404, 406, 408 may also be input to copy generator 238 as previously discussed.

Turning now to FIG. 4B, user interface 400′is illustrated for some embodiments, showing how parlays 412a, 412b may be generated based on the inputted narrative. User interface 400′may be displayed responsive to the user 210 selecting the obtain wagers affordance 410 in some embodiments. As shown, based on parameters 404, 406, 408, wager mapping engine 234 has created two parlays 412a, 412b that each includes three distinct wagers 414. Each parlay 412a, 412b involves the selected actors and corresponds to the selected storyline, which involves the selected actors having an explosive performance. Thus, as discussed above, this storyline may be associated with a positive sentiment such that wager mapping engine 234 may map wagers involving the over on proposition markets for the selected actors because the selected actors hitting on these wagers would correspond to the selected narrative of the actors having an explosive performance.

Each parlay 412a, 412b may have a copy 416a, 416b automatically generated by copy generator 238. The copy 416a, 416b may be configured to increase user engagement with the parlay 412a, 412b. For example, the copy 416a, 416b may include a headline 418, a graphic 420, and an emoji 422. The headline 418 may be text associated with the narrative and/or the wagers 414 that promotes the parlays 412a, 412b to the user 210. The graphic 420 may be a graphic associated with the selected actor, such as a team logo or a headshot of the selected actor. The emoji 422 may be selected based on the identified storyline and/or headline 418. For example, an exclamation emoji 422 accompanies the explosive storyline parlay, and an emoji 422 of the number two accompanies the headline 418 that reads “Two for Travis.”

Copy generator 238 may be retrained using user engagement data in some embodiments. The user engagement data may comprise data indicating whether a user interacted with the parlay 412a, 412b and/or how the user interacted with the parlay 412a, 412b. When the user selects a parlay 412a, 412b, the parlay 412a, 412b is added to a bet slip, and the user can then proceed to place the bet. Thus, the act of the user adding the parlay 412a, 412b to the bet slip but not actually placing the bet may be user engagement data used to retrain the copy generator 238. In some embodiments, the copy generator 238 is trained to optimize the selection of an emoji 422 presented with the copy 416a, 416b. For example, based on user engagement data, the copy generator 238 may learn that a first emoji 422 receives more interaction than a second emoji 422 and, as such, copy generator 238 may learn to produce copies 416a, 416b that prioritize inclusion of the first emoji 422 over the second emoji 422. As another example, copy generator 238 may learn from the user engagement data that headlines 418 that include alliteration see higher user interaction rates than those without and may adjust the generation of headlines 418 accordingly.

As discussed above, wager mapping engine 234 may identify and surface single wagers 414 instead of (or in addition to) creating parlays 412a, 412b from the identified wagers 414. For example, where only a single actor is identified (e.g., via parameters 404 or via narrative engine 228), a single wager 414 may be mapped and surfaced to the user 210 via the user interface. When surfacing a single wager 414, copy generator 238 may likewise generate a copy for the surfaced wager. As previously discussed, wager mapping engine 234 may identify markets associated with a narrative that are less popular than other markets. Thus, by surfacing these markets to users 210 and providing a copy 416a, 416b configured to increase user engagement with the surfaced market, overall user engagement with markets offered by the system 202 may be increased.

While user interface 400′is illustrated with respect to parlays 412a, 412b that are generated by wager mapping engine 234 being based on user-inputted parameters 404, 406, 408, it will be appreciated that parlays and wagers that are identified by wager mapping engine 234 based on a narrative identified by narrative engine 228 may likewise be surfaced to the user 210 in a user interface for the wagering system 202. Additionally, as new narratives are identified throughout a contest, parlays 412a, 412b may be replaced with the new narratives or new parlays 412a, 412b may be added alongside the currently-displayed narratives.

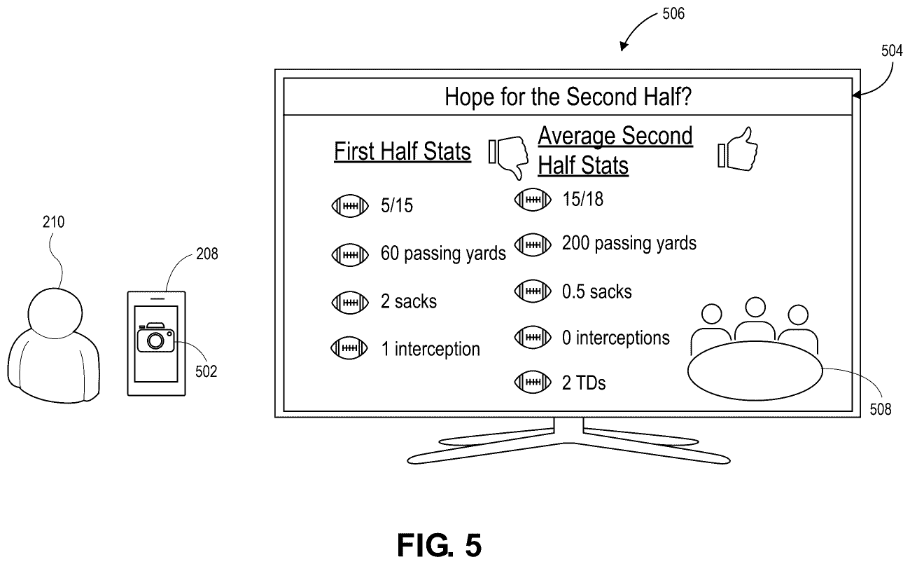

FIG. 5 illustrates an exemplary scenario for determining a narrative based on an image received from a user 210 in accordance with aspects of the present disclosure. As previously discussed, user 210 may operate a computing device 208 to interact with wagering system 202, for example, to place wagers on live contests via a user interface. In some embodiments, user 210 can provide data to system 202 that may be analyzed by narrative engine 228 in determining narratives.

Computing device 208 may include a camera 502 configured to capture images. In some embodiments, user 210 may use camera 502 to capture an image of a graphic 504 displayed on the broadcast 506 for a live contest 214. For example, as shown, the broadcast 506 is broadcasting a halftime show for the live contest 214 in which a panel of analysts 508 are discussing the events for the first half. As part of the discussion, the broadcast 506 displays a graphic 504 that provides a visual aid to the analysts'talking points.

As shown in the example graphic 504, the analysts 508 are discussing the poor first half performance of the quarterback, which is contrasted in graphic 504 with the quarterback's typically strong performance in the second half throughout the season. Thus, in some embodiments, user 210 can capture an image of graphic 504, transmit the image to server 204, whereby narrative engine 228 may analyze the image to determine a narrative from the image. For example, optical character recognition may be performed on the image to recognize the text in the image, which may then be fed to narrative engine 228 for narrative identification as discussed previously. For example, narrative engine 228 may identify a narrative for the quarterback to have a strong second half based on the text displayed in graphic 504. This narrative may then be passed to wager mapping engine 234, which may identify wagers corresponding to the strong second half narrative as discussed above. Additionally, the image of the graphic 504 may be communicated to wager mapping engine 234 for determining wagers based on the image. For example, wager mapping engine 234 may identify wagers and/or create a parlay corresponding to the quarterback exceeding each of the average statistics displayed in graphic 504. Furthermore, as discussed above, the broadcast data may include the audio and/or video data of the analysts'discussion, which may also be processed by narrative engine 228, wager mapping engine 234, copy generator 238, or any combination thereof in accordance with aspects of the present disclosure. For example, the audio data may be fed into copy generator 238, which may generate a headline based on the analysts'discussion.

In some embodiments, narrative engine 228 is trained to perform image analysis to analyze images received from users 210 of graphics 504 displayed during broadcasts of live contest 214. Thus, narrative engine 228 may receive as training data 302 a plurality of graphics 504 and may be trained to determine narratives based on content displayed as part of the graphics 504. In some embodiments, a separate OCR model (not shown) is configured to OCR the image, and this textual data is fed as live data 308 to narrative engine 228.

Turning now to FIG. 6, a method 600 is illustrated for some embodiments. Method 600 depicts the flow for identifying a narrative for one or more live contests, identifying wagers associated with the narrative, and surfacing the wagers to users in accordance with aspects of the present disclosure. Method 600 may begin at step 602 where narrative data may be received. The narrative data may be live data received in real-time during a live contest and may also include data received before the live contest began, such as news articles written about the game. The narrative data may include play-by-play data 218, broadcast data 222, social media data 224, other data sources 226, statistical data 230, wager data 232, or any combination thereof. Generally, the narrative data may include any data from which a narrative about the one or more live contests 214 can be extracted.

Next, at step 604, a narrative may be determined based on the narrative data. In some embodiments, multiple narratives are determined. The narrative may include at least one actor, at least one storyline, at least one sentiment, at least one time frame, or any combination thereof. For example, the narrative may involve a first player from a first game and a second player from a second game that are occurring simultaneously, each having their season-best game. Thus, in this example, the first player and the second player are the actors, the storyline is the season-best game, the sentiment is a positive sentiment, and the time frame is a single game. The narrative may be determined using narrative engine 228 or based on user input as discussed previously. In some embodiments, the narrative engine 228 is configured to populate the parameters 404, 406, 408 based on the narrative data from which a user 210 can build a narrative.

Thereafter, at step 606, one or more relevant wagers may be identified that corresponds to the identified narrative. The wagers may be based on markets offered by the sportsbook and/or may be custom wagers generated by system 202 as discussed above. When more than one wager is identified, the wagers may be combined into one or more parlays. In some embodiments, the wagers are selected based on the sentiment. For example, if the market allows for a binary option to be bet (e.g., an over or under proposition), the wager (the over or the under) may be selected based on whether the narrative is associated with a positive sentiment or a negative sentiment. As discussed previously, the narrative may be associated with more than one sentiment. For example, the narrative of a first team routing the second team may have a positive sentiment associated with the first team and a negative sentiment associated with the second team such that wagers involving the first team may involve the first team hitting the over a proposition, while wagers involving the second team may involve the second team finishing below the proposition.

Next, at step 608, copy for the identified wagers may be generated by copy generator 238. The copy may include a headline 418, a graphic 420, an emoji 422, or any combination thereof. Thereafter, at step 610, the wager, including the copy, may be surfaced to the user 210 via a graphical user interface. In some embodiments, the wager is surfaced via a live page for a live contest such that the wager is presented to the user 210 without the user 210 having to search through multiple user interfaces to locate the wager. Additionally, as narratives change and develop throughout a live contest 214, newly-identified wagers and/or parlays may replace old wagers in the live page such that the page reflects the most current narrative(s) surrounding the live contest 214.

At step 612, user engagement data with the surfaced wagers and generated parlays may be received. In some embodiments, the user engagement data includes whether the user bet on the surfaced wager or parlay, whether the user interacted with the wager or parlay at all, or the like. Generally, the user engagement data may include any success metric associated with the surfaced wager or generated parlay.

Lastly, at step 614, the user engagement data may be used to retrain the various machine learning models discussed herein. For example, the user engagement data may be fed back into the copy generator 238 to adjust the weights between the nodes of the neural network. Additionally, subject matter experts may provide feedback data to narrative engine 228, wager mapping engine 234, copy generator 238, or a combination thereof to adjust the outputs of the respective models.

Although the present disclosure has been described with reference to the embodiments illustrated in the attached drawing figures, it is noted that equivalents may be employed and substitutions made herein without departing from the scope of the present disclosure as recited in the claims.

Having thus described various embodiments, what is claimed as new and desired to be protected by Letters Patent includes the following:

1. One or more non-transitory computer-readable media storing computer-executable instructions that, when executed by at least one processor, perform a method of dynamically generating narrative-based parlays for a contest, comprising:
receiving data associated with the contest from a plurality of data sources;
determining, using a machine learning model and based on the data, a narrative for the contest, the narrative including an actor and a sentiment,
wherein the machine learning model is trained to identify narratives associated with contests using a set of training data including historical contest statistical data;
receiving, from a user and via a user computing device, an image of a broadcast graphic for the contest, the image captured via a camera of the user computing device;
wherein at least one of the actor or the sentiment of the narrative is further determined based in part on image analysis performed on the broadcast graphic;
identifying two or more wagers for the contest corresponding to the narrative and the sentiment of the narrative, the two or more wagers associated with the actor;
generating a parlay for the contest based on the two or more wagers;
generating, using a generative artificial intelligence model, a headline for the parlay including at least one of the actor or the sentiment; and
surfacing the parlay and the headline to the user via a graphical user interface of the user computing device.

2. The media of claim 1, further comprising:
determining, while the contest is ongoing, a new narrative associated with the contest; and
responsive to determining the new narrative, surfacing a second parlay with a second headline to the user via the graphical user interface.

3. The media of claim 1, wherein the method further includes surfacing a graphical image with the headline and the parlay.

4. (canceled)

5. The media of claim 1, wherein the data comprises social media data comprising one or more posts associated with the contest.

6. The media of claim 5, wherein determining the sentiment is based on sentiment analysis of the one or more posts.

7. A system for generating parlays based on identified live contest narratives, the system comprising:
at least one processor; and
one or more non-transitory computer-readable media storing computer-executable instructions that, when executed by the at least one processor, cause the system to perform a method of generating narrative-based parlays for an event, comprising:
receiving, during a live contest, data associated with the live contest from a plurality of data sources;
determining, based on the data, a narrative for the live contest, the narrative including an actor and a sentiment;
receiving, from a user and via a user computing device, an image of a broadcast graphic for the live contest, the image captured via a camera of the user computing device;
wherein at least one of the actor or the sentiment of the narrative is further determined based in part on image analysis performed on the broadcast graphic;
identifying a plurality of wagers associated with the actor and corresponding to the sentiment;
generating a parlay based on the plurality of wagers;
generating, using a generative artificial intelligence model, a headline for the parlay including at least one of the actor or the sentiment; and
surfacing the parlay including the headline to the user via a graphical user interface of the user computing device.

8. The system of claim 7, wherein the method further comprises:
determining, while the live contest is ongoing, a new narrative associated with the live contest; and
responsive to determining the new narrative, surfacing a second parlay with a second copy to the user via the graphical user interface.

9. The system of claim 7, wherein the method further comprises:
receiving user interaction data of user interactions with the headline; and
retraining the generative artificial intelligence model based on the user interaction data.

10. The system of claim 7, wherein the plurality of data sources includes an audio data source of a broadcast of the live contest.

11. The system of claim 7, wherein the method further comprises:
receiving a set of training data for training a machine learning model to identify the narrative; and
training the machine learning model using the set of training data,
wherein the set of training data comprises historical statistical data.

12. (canceled)

13. The system of claim 7, wherein the actor comprises a player participating in the live contest.

14. A method for surfacing narrative-based wagers identified during live contests, comprising:
receiving a set of training data for training a machine learning model, the set of training data including narrative data associated with historical contests;
training the machine learning model to identify narratives associated with the live contests using the set of training data;
receiving, during at least one live contest, live data for the at least one live contest;
identifying, using the machine learning model, a narrative for the at least one live contest, the narrative including at least one actor and a storyline;
receiving, from a user and via a user computing device, an image of a broadcast graphic for the at least one live contest, the image captured via a camera of the user computing device;
wherein at least one of the at least one actor or the storyline of the narrative is further determined based in part on image analysis performed on the broadcast graphic;
determining a plurality of wagers associated with the at least one actor and the storyline;
generating a headline for a wager of the plurality of wagers, the headline for the wager including at least one of the at least one actor or the storyline; and
surfacing, to the user and via a graphical user interface of the user computing device, the wager of the plurality of wagers.

15. The method of claim 14, wherein the at least one actor comprises at least one team participating in the at least one live contest.

16. The method of claim 14, further comprising:
automatically generating, using a generative artificial intelligence model, one or more visuals associated with the headline for the wager; and
causing display of the headline and the one or more visuals for the wager to the user.

17. The method of claim 14, wherein the set of training data includes historical broadcast data from a historical contest involving the at least one actor.

18. The method of claim 17, wherein the live data comprises audio data and one or more graphics.

19. The method of claim 14, wherein the storyline is associated with the at least one live contest and one or more historical contests involving the at least one actor.

20. The method of claim 14, wherein the at least one live contest comprises a first live contest and a second live contest occurring concurrently.

21. The method of claim 14, wherein the wager is a custom wager and the method further comprises:
pricing the custom wager by:
running a plurality of simulations of the at least one live contest based on historical contest data;
determining a plurality of probabilities of events occurring in the at least one live contest based on the plurality of simulations; and
determining a price for the custom wager based at least in part on the plurality of probabilities of the events.

22. The media of claim 1, wherein a wager of the two or more wagers is a custom wager and wherein the method further comprises:
pricing the custom wager by:
running a plurality of simulations of the contest based on historical contest data;
determining a plurality of probabilities of events occurring in the contest based on the plurality of simulations; and
determining a price for the custom wager based at least in part on the plurality of probabilities of the events.
